(19) United States
(12) Patent Application Publication
(10) Pub. No.: US 2012/0272847 A1
(43) Pub. Date: Nov. 1, 2012

(54) PRINTING METHOD AND PERFECTING PRINTING PRESS FOR RECTO AND VERSO PRINTING ON SHEETS

(75) Inventor: STEFFEN DERHARDT, GERLINGEN (DE)

(73) Assignee: HEIDELBERGER DRUCKMASCHINEN AG, HEIDELBERG (DE)

(21) Appl. No.: 13/457,742

(22) Filed: Apr. 27, 2012

(30) Foreign Application Priority Data
Apr. 27, 2011 (DE) 10 2011 018 777.4

(51) Int. Cl. B41F 5/02

(52) U.S. Cl. 101/229; 101/483

(57) ABSTRACT

A printing method for printing on both sides of sheets in a perfecting printing press includes first, second and third steps. In the first step, the sheet is transported on a first cylinder, with the first cylinder having its temperature controlled to a first temperature, and the sheet is printed on a first side. In a second step, the sheet is turned by a turning device. In a third step, the sheet is transported on a second cylinder, with the second cylinder having its temperature controlled to a second temperature, which is different from the first temperature, and the sheet is printed on a second side. A perfecting printing press for recto and verso printing on sheets for implementing the printing method is also provided.

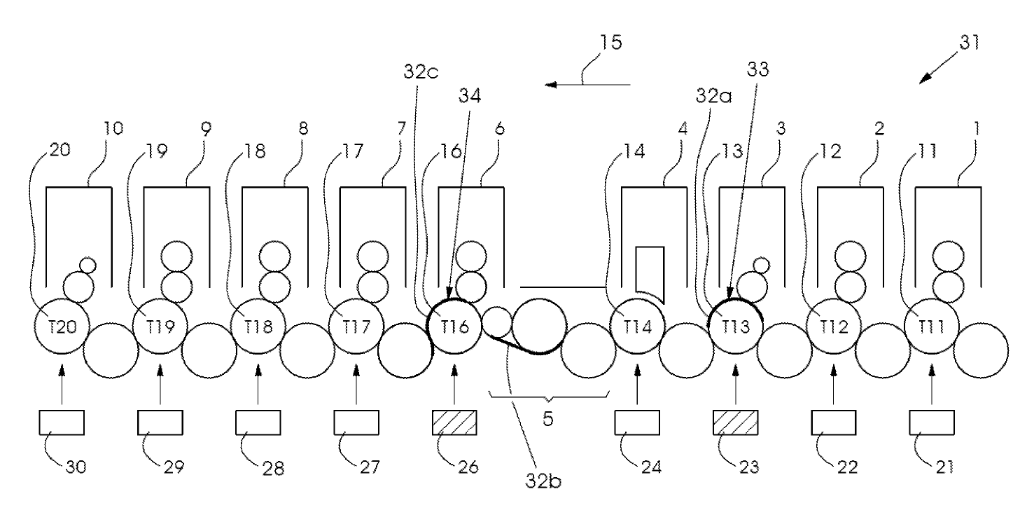

### CROSS-REFERENCE TO RELATED APPLICATION

This application claims the priority, under 35 U.S.C. §119, of German Patent Application DE 10 2011 018 777.4, filed Apr. 27, 2011; the prior application is herewith incorporated by reference in its entirety.

### BACKGROUND OF THE INVENTION

### Field of the Invention:

The present invention relates to a printing method for printing both sides of sheets and to a perfecting printing press or perfector for recto and verso printing on sheets.

During verso printing in perfecting printing presses, there is the risk of ink set-off from the already printed recto side to the impression cylinder.

In order to counter that risk, it is proposed in German Patent Application DE 197 16 424 A1 to provide the impression cylinder downstream of the turning device with a silicone rubber layer. In addition, the cylinder can be cooled to a temperature below 28° C. A conduit system for cooling medium can be disposed in the interior of the cylinder for the cooling. The silicone rubber layer acts as an ink-repelling layer and the cooling is used to intensify that ink-repelling effect.

Another problem occurring in the printing process is the inadequate drying of the sheets.

Attempts could be made to accelerate the drying of the printing ink through the use of a treatment agent which includes an infrared absorber, as described in U.S. Pat. No. 7,913,622.

With reference to that problem of inadequate drying, German Patent Application DE 10 2007 056 899 A1, corresponding to U.S. patent application Publication Nos. US 2008/0134915A1 and US 2009/0277352A1, includes a description of a printing press in which the sheet is warmed in a varnishing unit upstream of a turning device. As a result of their contact with a heated impression cylinder belonging to the varnishing unit, the sheets are warmed to a temperature above the temperature of the printing units of the printing press. In order to heat the impression cylinder, a heated fluid can be caused to flow through the latter.

A further problem occurring when printing with a perfecting printing press is an insufficient level of gloss on the printed recto side of the sheets. Until now, no satisfactory solution to that problem has been found.

### SUMMARY OF THE INVENTION

It is accordingly an object of the invention to provide a printing method and a perfecting printing press for recto and verso printing on sheets, which overcome the hereinafore-mentioned disadvantages of the heretofore-known methods and devices of this general type and in which a high level of gloss can be achieved on the printed recto side.

With the foregoing and other objects in view there is provided, in accordance with the invention, a printing method for printing both sides of sheets in a perfecting printing press. The method comprises:

In a first method step, the respective sheet, as it passes through the perfecting printing press, is transported on a first cylinder of the perfecting printing press, with the first cylinder having its temperature controlled to a first temperature. In the first method step, the respective sheet is printed on a first side.

In a second method step, the respective sheet, as it passes through the perfecting printing press, is turned through the use of a turning device of the perfecting printing press.

In a third method step, the respective sheet, as it passes through the perfecting printing press, is transported on a second cylinder of the perfecting printing press, with the second cylinder having its temperature controlled to a second temperature being different from the first temperature. In the third method step, the respective sheet is printed on a second side.

A particularly high level of gloss can be achieved on the first side of the sheet by using the method.

In accordance with another mode of the invention, the first cylinder being used is an impression cylinder.

In accordance with a further mode of the invention, the first cylinder is a constituent part of a varnishing unit, which is disposed before the turning device, as seen in the sheet transport direction.

In accordance with an added mode of the invention, in the first method step, the respective sheet is printed successively in a plurality of offset printing units, which are disposed before the turning device, as seen in the sheet transport direction.

In accordance with an additional mode of the invention, the first cylinder is heated to the first temperature and the first temperature is higher than a temperature of impression cylinders of the perfecting printing press. These impression cylinders are preferably impression cylinders of the perfecting printing press of which the temperature is not controlled, i.e. neither heated nor cooled.

In accordance with yet another mode of the invention, the second cylinder being used is an impression cylinder.

In accordance with yet a further mode of the invention, the second cylinder is a constituent part of an offset printing unit, which is disposed after the turning device, as seen in the sheet transport direction.

In accordance with yet an added mode of the invention, in the second method step, the respective sheet is varnished in a varnishing unit, which is disposed after the turning device, as seen in the sheet transport direction.

In accordance with yet an additional mode of the invention, the second cylinder is cooled to the second temperature and the second temperature is lower than a temperature of impression cylinders of the perfecting printing press. These impression cylinders are preferably those impression cylinders already mentioned of which the temperature is not controlled, i.e. are neither heated nor cooled.

With the objects of the invention in view, there is concomitantly provided a perfecting printing press for recto and verso printing on sheets. The perfecting printing press comprises at least one first unit for printing, varnishing or drying a first side of the sheet, the first unit having a first cylinder for the sheet transport. Furthermore, the perfecting printing press includes at least one second unit for printing, varnishing or drying a second side of the sheet, the second unit having a second cylinder for the sheet transport. In addition, the perfecting printing press includes at least one temperature control device for controlling the temperature of the first cylinder to a first temperature and of the second cylinder to a second temperature, which is different from the first temperature.

Accordingly, there can be a first temperature control device for controlling the temperature of the first cylinder and a second temperature control device for controlling the temperature of the second cylinder and, likewise, there can be a common temperature control device controlling the temperature both of the first cylinder and of the second cylinder.

Other features which are considered as characteristic for the invention are set forth in the appended claims.

Although the invention is illustrated and described herein as embodied in a printing method and a perfecting printing press for recto and verso printing on sheets, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SINGLE VIEW OF THE DRAWING

The FIGURE of the drawing is a longitudinal-sectional view of a sheet-fed printing press having an in-line construction with a plurality of printing units disposed one after another.

### DETAILED DESCRIPTION OF THE INVENTION

Referring now in detail to the single figure of the drawing, there is seen an in-line, sheet-fed, perfecting printing press 31 with a plurality of printing units disposed one after another and a turning device 5 for turning sheets during perfecting operation of the perfecting printing press 31. The turning device 5 can be switched from a mode for perfecting operation to a mode for pure recto operation, in which the sheets pass through the turning device 5 without being turned by the latter. A non-illustrated sheet feeder, printing units 1, 2, a varnishing unit 3 and a drying unit 4 are disposed upstream of the turning device 5, in the order stated, as seen in a sheet transport direction 15. Printing units 6, 7, 8 and 9, a varnishing unit 10 and a non-illustrated sheet delivery are disposed downstream of the turning device 5, in the order stated, as seen in the sheet transport direction 15. The printing units 1, 2 and 6 to 9 are planographic or lithographic offset printing units. The varnishing units 3, 10 are used to apply a protective varnish or clear varnish or a similar coating liquid to the respective offset printed image.

The printing units 1, 2 and 6 to 9 and the varnishing units 3, 10 in each case include a cylinder 11, 12, 13, 16, 17, 18, 19 and 20 transporting the sheets, which is an impression cylinder. The drying unit 4 likewise includes a cylinder 14 transporting the sheets. Further cylinders for transporting the sheets are disposed between the impression cylinders and in the turning device 5. The cylinders 11 to 14 and 16 to 20 are each assigned a temperature control device 21, 22, 23, 24, 26, 27, 28, 29 and 30, through the use of which a temperature control liquid is circulated through the respective cylinder. The temperature control devices 21 to 24 and 26 to 30 can also be combined in groups to form a common temperature control device for the cylinders 11 to 14 upstream of the turning device 5 and a common temperature control device for the cylinders 16 to 20 downstream of the turning device 5 or in a similar form. Designations “32a,” “32b” and “32c” illustrate one and the same sheet in various positions as it passes through the perfecting printing press 31.

The sequence when printing the sheet is as follows: firstly, the sheet is in each case provided with an offset print on its first side (front side) 33 in the printing units 1, 2. After that, the first side 33 of the sheet is varnished in the varnishing unit 3 in order to provide the offset prints with a glossy and protective layer. The varnishing unit 3 is the last printing or varnishing unit before the turning device 5. During the varnishing, the sheet 32a rests on the rotating cylinder 13 and the latter is warmed by the temperature control device 23 to a temperature T13. The temperature T13 of the cylinder 13 is at least 10 K and at most 30 K above a temperature T11=T12=T14=T17=T18=T19=T20 of the cylinders 11, 12, 14 and 17 to 20, which can be about 30° C. Following the varnishing, the recto printed image on the first side 33 of the sheet is dried in the drying unit 4 through the use of hot or warm air and/or infrared radiation and, in the process, the sheet is transported by the cylinder 14.

Next, the sheet 32b passes through the turning device 5 and is turned in the latter.

After that, the turned sheet 32c is in each case provided with an offset print on its second side (rear side) 34 in the printing units 6 to 9. During the printing of the sheet 32c in the printing unit 6, the sheet 32c is transported on the cylinder 16 and, in the process, the latter is cooled by the temperature control device 26 to a temperature T16. The temperature T16 of the cylinder 16 is at least 10 K and at most 20 K lower than a joint or common temperature T11=T12=T14=T17=T18=T19=T20 of the cylinders 11, 12, 14, 17 to 20, which can be about 30° C.

For example, the cylinder 13 participating in the recto printing may be warmed to 55° C. and at the same time the cylinder 16 participating in the verso printing may be cooled to 15° C. The temperature difference between the warmed cylinder 13 and the cooled cylinder 16 is at least 20 K and at most 50 K. The printing unit 6 is the first printing or varnishing unit after the turning device 5. The unit 6 follows the turning device 5 directly.

After that, the verso printed image on the sheet 32c is varnished over in the varnishing unit 10, in order to provide the printed image on the second side 34 of the sheet with a glossy and protective layer.

Various modifications of the operating and printing method are possible:

In one modification, not only the cylinder 13 of the varnishing unit 3 but, in addition, also the cylinders 11, 12 of the printing units 1, 2 and/or the cylinder 14 of the drying unit 4 are warmed to the temperature of about 40 to 60° C. Accordingly, the cylinder transporting the sheet and belonging to at least one of the units 1 to 4 disposed before the turning device 5 in the sheet transport direction 15 or a plurality of these units 1 to 4 or all of the units 1 to 4 is warmed or heated to the aforesaid elevated operating temperature.

In a further modification, which can be provided independently or together with the modification explained previously, not only the cylinder 16 of the printing unit 6 but, in addition, also the cylinders 17, 18, 19 of the printing units 7 to 9 and/or the cylinder 20 of the varnishing unit 10 are cooled to the temperature of about 10 to 20° C.

1. A printing method for printing both sides of sheets in a perfecting printing press, the method comprising:
during passage of a respective sheet through the perfecting printing press:
in a first step, transporting the respective sheet on a first cylinder of the perfecting printing press, while controlling a temperature of the first cylinder to a first temperature and printing on a first side of the respective sheet;
in a second step, turning the respective sheet with a turning device of the perfecting printing press; and
in a third step, transporting the respective sheet on a second cylinder of the perfecting printing press, while controlling a temperature of the second cylinder to a second temperature being different than the first temperature and printing on a second side of the respective sheet.

2. The printing method according to claim 1, which further comprises using an impression cylinder as the first cylinder.

3. The printing method according to claim 1, which further comprises using, as the first cylinder, a constituent part of a varnishing unit disposed upstream of the turning device, in a sheet transport direction.

4. The printing method according to claim 1, which further comprises carrying out the first step by successively printing the respective sheet in a plurality of offset printing units disposed upstream of the turning device, in a sheet transport direction.

5. The printing method according to claim 1, which further comprises carrying out the first step by heating the first cylinder to the first temperature and setting the first temperature higher than a temperature of impression cylinders of the perfecting printing press.

6. The printing method according to claim 1, which further comprises using an impression cylinder as the second cylinder.

7. The printing method according to claim 1, which further comprises using, as the second cylinder, a constituent part of an offset printing unit disposed downstream of the turning device, in a sheet transport direction.

8. The printing method according to claim 1, which further comprises carrying out the second step by varnishing the respective sheet in a varnishing unit disposed downstream of the turning device, in a sheet transport direction.

9. The printing method according to claim 1, which further comprises carrying out the second step by cooling the second cylinder to the second temperature and setting the second temperature lower than a temperature of impression cylinders of the perfecting printing press.

10. A perfecting printing press for recto and verso printing on sheets, the perfecting printing press comprising:
at least one first unit configured for printing, varnishing or drying a first side of a sheet, said first unit having a first cylinder configured for sheet transport;
at least one second unit configured for printing, varnishing or drying a second side of the sheet, said second unit having a second cylinder configured for sheet transport; and
at least one temperature control device configured for controlling a temperature of said first cylinder to a first temperature and configured for controlling a temperature of said second cylinder to a second temperature being different than said first temperature.

11. The perfecting printing press according to claim 10, which further comprises means for implementing the printing method according to claim 1.
